(19) United States
(12) Patent Application Publication
(10) Pub. No.: US 2025/0163944 A1
(43) Pub. Date: May 22, 2025

(54) Clip System for Attaching Objects to Hollow Members

(71) Applicant: Proveli, LLC, Atlanta, GA (US)

(72) Inventors: Thomas Jason Cyphers, Atlanta, GA (US); Reinhardt Franklin Cyphers, Atlanta, GA (US); Casey Scott Cotter, Yakima, WA (US); John Ervin Seitz, JR., Bloomington, IN (US)

(21) Appl. No.: 18/954,043

(22) Filed: Nov. 20, 2024

Related U.S. Application Data
(60) Provisional application No. 63/571,206, filed on Mar. 28, 2024.
(60) Provisional application No. 63/600,841, filed on Nov. 20, 2023.

(51) Int. Cl. F16B 2/20; F16B 5/06

(52) U.S. Cl. CPC F16B 2/20; F16B 5/0607

(57) ABSTRACT

An apparatus for attaching objects includes a hollow member that has a slot with opposite first and second notches extending along the length of the slot. The apparatus further includes a clip that includes first and second detents located on opposite first and second sides of the clip. The clip may be inserted into the slot such that the first detent engages one of the first notches and the second detent engages one of the second notches opposite the first notch engaged by the first detent to attach the first clip to the hollow member. The clip is configured to enable the first and second detents to disengage from their respective first and second notches to enable the clip to be moved to a position where the first detent can engage another one of the first notches and the second detent can engage another one of the second notches.

### FIELD OF THE INVENTION

This invention pertains to an apparatus that utilizes clips for the attachment of signs or other objects to sign posts, frames, or other structures with hollow members. Specifically, the invention relates to an apparatus having a novel clip system that offers quick and versatile sign-hanging capabilities for signs of varying sizes and fastener locations.

### BACKGROUND OF THE INVENTION

Attaching signs to hollow members often involves time-consuming processes and adjustments, especially when accommodating signs of different sizes and fastener locations. There is a need to provide an inexpensive way to attach signs and other objects that simplifies the sign-hanging process, eliminating the need for frequent modifications to the hollow member.

### SUMMARY OF THE INVENTION

In one aspect of the present invention, a clip for attaching objects is provided. The clip includes first and second sides located opposite each other and a first detent located on the first side of the clip and a second detent located on the second side of the clip. The clip is configured to be inserted into a slot of a hollow member. The slot has first and second longitudinal ends. The slot includes first notches extending along a length of the first longitudinal end. The slot includes second notches extending along the length of the second longitudinal end. The first and second notches are located opposite each other. The clip is configured to be inserted into the slot such that the first detent engages one of the first notches and the second detent engages one of the second notches opposite the first notch engaged by the first detent. The clip is configured to enable the first and second detents to disengage from their respective first and second notches to enable the clip to be moved along a length of the first slot to a position where the first detent can engage another one of the first notches and the second detent can engage another one of the second notches.

In another aspect of the present invention, a hollow member for attaching objects is provided. The hollow member includes a slot. The slot has first and second longitudinal ends. The slot includes first notches extending along a length of the first longitudinal end. The slot includes second notches extending along the length of the second longitudinal end. The first and second notches are located opposite each other. The slot is configured to receive a clip. The clip includes first and second sides located opposite each other. The clip includes a first detent located on the first side of the clip and a second detent located on the second side of the clip. The slot is configured to receive the clip such that the first detent engages one of the first notches and the second detent engages one of the second notches opposite the first notch engaged by the first detent. The hollow member is configured to enable the first and second detents to disengage from their respective first and second notches to enable the clip to be moved along a length of the slot to a position where the first detent can engage another one of the first notches and the second detent can engage another one of the second notches.

In another aspect of the present invention, an apparatus for attaching objects is provided. The apparatus includes a hollow member. The hollow member includes a first slot. The first slot has first and second longitudinal ends. The first slot includes first notches extending along a length of the first longitudinal end. The first slot includes second notches extending along the length of the second longitudinal end. The first and second notches are located opposite each other. The apparatus further includes a first clip. The first clip includes first and second sides located opposite each other. The first clip includes a first detent located on the first side of the first clip and a second detent located on the second side of the first clip. The first clip is configured to be inserted into the first slot such that the first detent engages one of the first notches and the second detent engages one of the second notches opposite the first notch engaged by the first detent to attach the first clip to the hollow member. The first clip is configured to enable the first and second detents to disengage from their respective first and second notches to enable the first clip to be moved along a length of the first slot to a position where the first detent can engage another one of the first notches and the second detent can engage another one of the second notches.

Other aspects of the disclosed invention will become apparent from the following detailed description, the accompanying drawings and the appended claims.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front and bottom perspective view of an apparatus according to an embodiment of the present invention.

FIG. 2 is a bottom view of the apparatus of FIG. 1.

FIG. 3 is a top and front perspective view of the clip of the apparatus of FIG. 1.

FIG. 4 is a top and rear perspective view of the clip of the apparatus of FIG. 1.

FIG. 5 is a front view (relative to FIG. 1) of the clip of the apparatus of FIG. 1.

FIG. 6 is a bottom view of the clip of the apparatus of FIG. 1.

FIG. 7 is a top view of the clip of the apparatus of FIG. 1.

FIG. 8 is a right side view of the clip of the apparatus of FIG. 1.

FIG. 9 is a bottom view of a portion of the apparatus showing one of the slots and related elements.

FIG. 10 is a sectional view taken along line 10-10 of FIG. 9.

FIG. 11 is a sectional view taken along line 11-11 of FIG. 9.

### DETAILED DESCRIPTION OF THE INVENTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

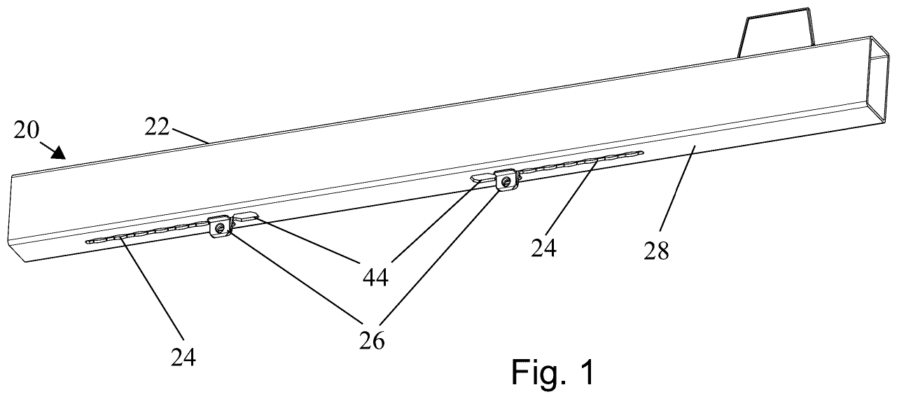

Throughout the present description, the terms “upper”, “lower”, “top”, “bottom”, “left”, “right”, “front”, “forward”, “rear”, and “rearward” shall define directions or orientations with respect to the apparatus as illustrated in FIG. 1, which shows a front and bottom perspective view of the apparatus. It will be understood that the spatially relative terms “upper”, “lower”, “top”, “bottom”, “left”, “right”, “front”, “forward”, “rear”, and “rearward” are intended to encompass different orientations of the clip in use or operation in addition to the orientation depicted in the figures. For example, if the clip in the figures is turned over, elements described as “upper” elements or features would then be “lower” elements or features.

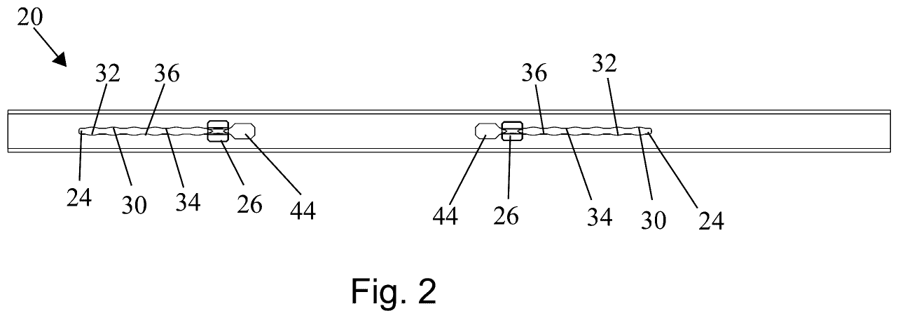

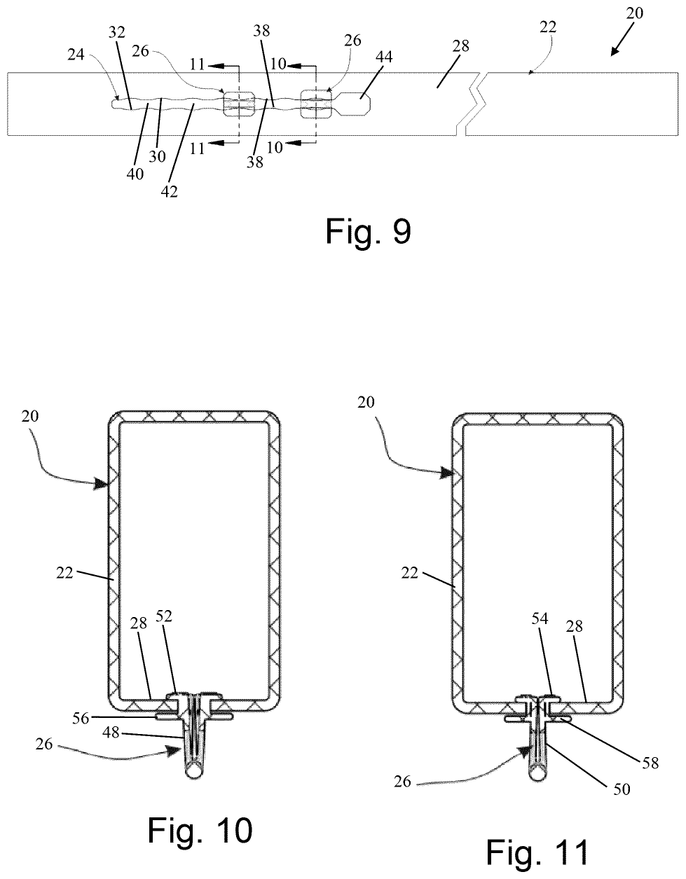

FIGS. 1 and 2 show an apparatus 20 for attaching objects such as signs according to an embodiment of the present invention. The apparatus 20 includes a hollow support member 22, a pair of elongated slots 24, and a pair of V-shaped clips 26. The hollow support member 22 may be a variety of shapes and types. In this embodiment, the hollow support member 22 is a cross member in the form of a rectangular box. The slots 24 are formed on a bottom wall 28 of the hollow support member 22 and are spaced longitudinally from each other along the length of the hollow support member 22. Each of the slots 24 is similar in structure and function with similar elements so only one slot 24 will be described in the interest of brevity. As best illustrated in FIG. 9, each slot 24 includes first and second notches 30, 32 formed on opposite first and second longitudinal ends 34, 36 (FIG. 2) of the slot 24. The notches 30, 32 are spaced longitudinally from each other along their respective longitudinal ends 34, 36. A respective tooth 38 formed from the bottom wall 28 is located between each longitudinally adjacent notches such that the narrow portions 40 of the slot 24 between opposite teeth 38 are narrower than wide portions 42 of the slot 24 between opposite first and second notches 30, 32. The slot 24 has an access portion 44 at an inner axial end of the slot that is of a larger width than the remaining portion of the slot 24. The access portion 44 is sized to enable the entire clip 26 to be inserted into the slot 24.

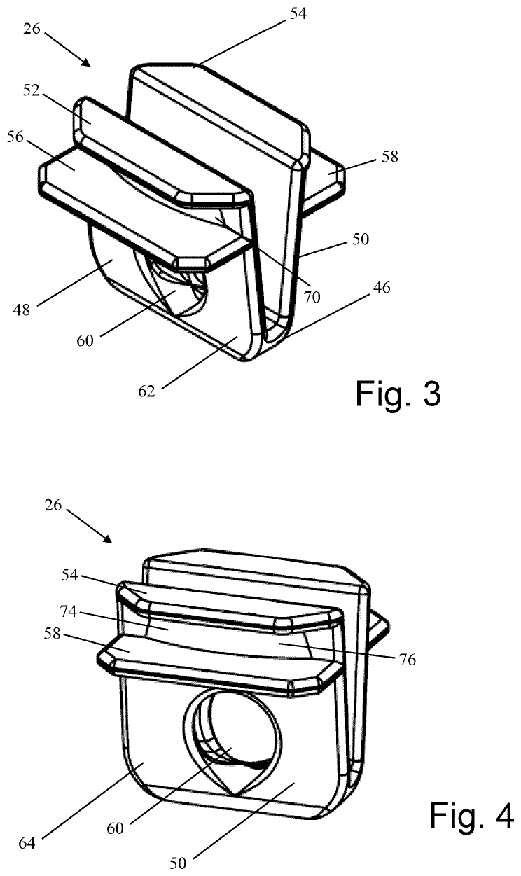

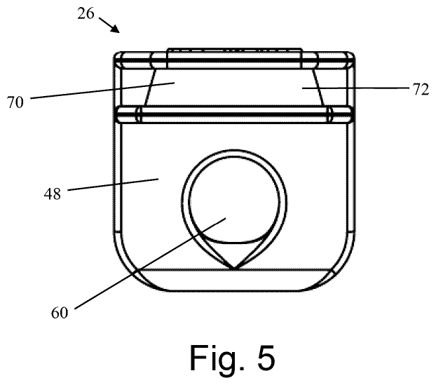

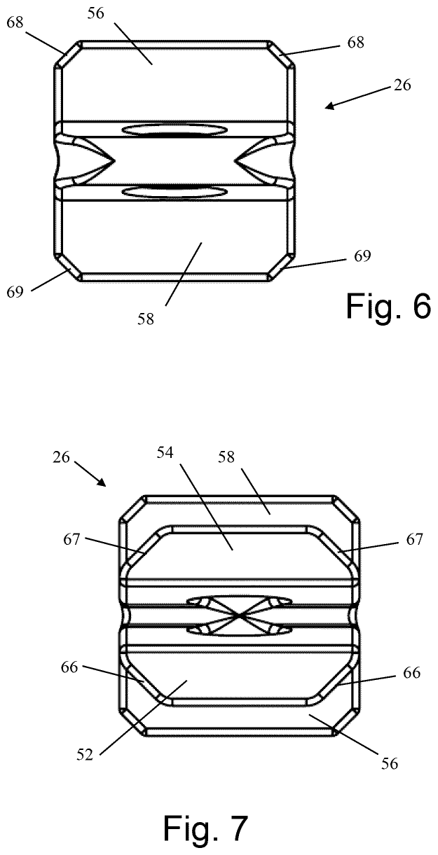

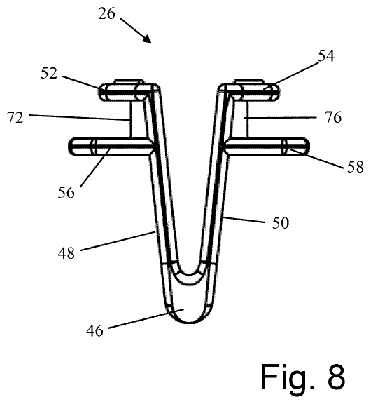

FIGS. 3-8 show one of the clips 26. Each of the clips 26 is similar in structure and function with similar elements so only one clip 26 will be described in the interest of brevity. Referring to FIG. 3, each clip 26 comprises an elongated body 46, opposite first and second clastic arms 48, 50, first and second top wings 52, 54, first and second bottom wings 56, 58, and a mounting aperture 60. Each of the arms 48, 50 is integrally formed in one piece with the body 46 and extends along the length of the body 46. The first and second arms 48, 50 are located on opposite front and rear sides 62, 64 of the clip 26 with a gap between them as illustrated in FIGS. 3 and 4. The arms 48, 50 also extend upwardly from the body 46 and slope outwardly away from each other as the arms 48, 50 extend upwardly from the body 46 to define the V-shaped configuration of the clip 26 as also seen in FIG. 8. The first top wing 52 is integrally formed in one piece with the first arm 48 and extends laterally outward from a top end of the first arm 48 and also extends along the length of the first arm 48. The first top wing 52 is generally rectangular but with beveled outer corners 66 (FIGS. 3 and 7). The first bottom wing 56 is integrally formed in one piece with the first arm 48 and extends laterally outward from a lower location of the first arm 48 and also extends along the length of the first arm 48. The first bottom wing 56 is generally rectangular but with beveled outer corners 68 (FIGS. 3 and 6). The first bottom wing 56 is parallel to the first top wing 52 and extends laterally outward a further distance than the first top wing 52. The first arm 48 includes a convexly curved first projection 70 (FIGS. 3 and 5) on its outer side between the first top and bottom wings 52, 56. The first projection 70 of the first arm 48 between the first top and bottom wings 52, 56 defines a first detent 72 (FIG. 5).

The second top wing 54 is integrally formed in one piece with the second arm 50 and extends laterally outward from a top end of the second arm 50 and also extends along the length of the second arm 50. The second top wing 54 is generally rectangular but with beveled outer corners 67 (FIGS. 4 and 7). The second bottom wing 58 is integrally formed in one piece with the second arm 50 and extends laterally outward from a lower location of the second arm 50 and also extends along the length of the second arm 50. The second bottom wing 58 is generally rectangular but with beveled outer corners 69 (FIGS. 4 and 6). The second bottom wing 58 is parallel to the second top wing 54 and extends laterally outward a further distance than the second top wing 54. The second arm 50 includes a convexly curved second projection 74 (FIG. 4) between the second top and bottom wings 54, 58. The second projection 74 of the second arm 50 between the second top and bottom wings 54, 58 defines a second detent 76 (FIG. 4). The mounting aperture 60 is formed in the first and second arms 48, 50 and extends laterally through the first and second arms 48, 50 as illustrated in FIGS. 3-8.

The clips 26 are removably attached to the hollow support member 22 at their respective slots 24 by inserting the clip 26 through the access portion 44 at its respective slot 24. One clip 26 may be removably attached to the hollow support member 22 at one slot 24 and the other clip 26 may be removably attached to the hollow support member 22 at the other slot 24 as shown in FIGS. 1 and 2. Alternatively, both clips 26 may be removably attached to the same slot 24 as shown in FIG. 9. When the clip 26 is attached to the hollow support member 22, the bottom wall 28 is sandwiched between the first top and bottom wings 52, 56 and also the second top and bottom wings 54, 58 to hold the clip 26 and prevent the clip 26 from moving upwardly and downwardly out of the slot 24 as illustrated in FIGS. 10 and 11. The clip 26 can be moved back and forth along the length of the slot 24 stopping at a selected pair of first and second notches 30, 32 corresponding to a desired position along the length of the slot 24. The elasticity of the first and second arms 48, 50 bias the arms outwardly such that the first and second projections 70, 74 are urged against their respective first and second longitudinal ends 34, 36 at the selected first and second notches 30, 32.

The projections 70, 74 are received into and engage the selected pair of first and second notches 30, 32, so that the first and second detents 72, 76 defined by the first and second projections 70, 74 engage their respective first and second notches 30, 32 and removably secure the clip 26 to the hollow support member 22 at the selected pair of first and second notches 30, 32 and prevent the clip 26 from moving along the slot as seen in FIGS. 9 and 10. The convex curve of each projection matches the curve of its respective notch to enable the projection to closely fit into its respective notch. As mentioned above, the bottom wall 28 is also sandwiched between the top and bottom wings to further hold the clip 26 to the hollow member 22 and prevent the clip 26 from moving upwardly and downwardly out of the slot 24. In an alternative arrangement, each of the first and second arms of the clip may include only one respective wing that may be sandwiched between top and bottom wings attached to or integrally formed in one piece with the bottom wall at the opposite first and second longitudinal ends of the slot to hold the clip to the hollow support member and prevent the clip from moving upwardly and downwardly out of the slot.

To move the clip 26 to another pair of first and second notches 30, 32, the clip 26 is squeezed inwardly to move the first and second arms 48, 50 toward each other such that the first and second arms disengage 48, 50 from their respective first and second notches 30, 32. The clip 26 continues to be squeezed until the distance between the first and second arms 48, 50 is decreased enough to enable the first and second arms 48, 50 to be slidably received in each of the narrow portions 40 of the slot located between the opposite teeth 38 as seen in FIGS. 9 and 11. The clip 26 may then be moved longitudinally along the slot 24 to the selected another pair of first and second notches 30, 32. Then, the squeezing force is release from the clip 26, which in turn enables the arms 48, 50 to flex or move outwardly until the projections 70, 74 are received into and engage their respective first and second notches 30, 32 of the another pair, so that the first and second detents 72, 76 defined by the first and second projections 70, 74 engage their respective first and second notches 30, 32 and removably secure the clip 26 to the hollow support member 22 at the selected pair of first and second notches 30, 32 and prevent the clip 26 from moving along the slot 24. As seen in FIGS. 1 and 2, once the pair of clips 26 are positioned along their respective slots 24, a sign or other object can be mounted to the clips by fastening screws, bolts or other fasteners, or a carbiner through the mounting apertures 60. To remove the clip 26 from the slot 24, the clip 26 may be squeezed inwardly as previously mentioned and moved longitudinally along the slot 24 toward the access portion 44, where the slot 24 is large enough to allow the top and bottom wings to be removed from the bottom wall 28 and the clip 26 to be removed from the slot 24. The access portion 44 is sized to enable the entire clip to be inserted into the slot 24 to enable the bottom wall 28 to be sandwiched between the top and bottom wings. The access portion 44 can also be small enough for only the top wings to fit through when they are squeezed together.

In essence, the clip 26 is inserted into the slot 24, allowing the detents to engage with the notches, creating a secure connection. The clip may be made of a plastic that has sufficient elasticity to enable the arms to flex towards each other when they are squeezed together and then away from each other when the squeezing force is removed. The wings of the clip sandwich the bottom wall of the hollow support member, holding the clip securely to the hollow support member. The clip can be moved back and forth within the slot, stopping at the notches. To accommodate varying fastener locations, the clip can be squeezed together to disengage from the notches, enabling indexing between pairs of indents or notches in the slot. This innovative design enables quick and simple sign hanging of varying sign sizes and/or with different fastener locations without requiring modifications to the hollow support member. The advantages of the present invention include rapid and versatile sign-hanging process, a secure attachment of the signs, the attachment of signs of different sizes and fastener locations, elimination of the need for frequent cross member modifications, enhanced efficiency in the sign installation process, and less expensive production costs.

This adjustability is facilitated by the ability to squeeze the clip, disengaging the detents from the notches and enabling repositioning along the slot. The system is designed to be cost-effective and user-friendly, offering a rapid and reliable method for hanging signs, which is less expensive and more versatile than traditional methods. This clip system is particularly suitable for use in retail environments, exhibitions, and public spaces where signs need to be changed or repositioned frequently.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above-described embodiment, method, and examples, but by all embodiments and methods within the scope and spirit of the invention.

What is claimed is:

1. A clip for attaching objects comprising:
first and second sides located opposite each other;
a first detent located on the first side of the clip and a second detent located on the second side of the clip, wherein the clip is configured to be inserted into a slot of a hollow member, wherein the slot has first and second longitudinal ends, wherein the slot includes first notches extending along a length of the first longitudinal end, wherein the slot includes second notches extending along the length of the second longitudinal end, wherein the first and second notches are located opposite each other, wherein the clip is configured to be inserted into the slot such that the first detent engages one of a plurality of first notches and the second detent engages one of the second notches opposite the first notch engaged by the first detent, wherein the clip is configured to enable the first and second detents to disengage from their respective first and second notches to enable the clip to be moved along a length of the first slot to a position where the first detent can engage another one of the first notches and the second detent can engage another one of the second notches.

2. The clip of claim 1 further comprising a first pair of top and bottom wings, wherein the first pair of top and bottom wings extends outwardly from the first side of the clip, wherein the clip includes a second pair of top and bottom wings, wherein the second pair of top and bottom wings extends outwardly from the second side of the clip that is opposite the first side, wherein each of the first and second pairs of the top and bottom wings is configured to sandwich a wall of the hollow member when the clip is inserted into the slot to hold the clip to the hollow member.

3. The clip of claim 2 further comprising a first arm located on the first side of the clip and a second arm located on the second side of the clip, wherein the first and second arms extend upwardly and outwardly away from each other together forming a V-shape configuration, wherein the first arm includes a first projection that defines the first detent, wherein the second arm includes a second projection that defines the second detent, wherein the first pair of top and bottom wings extends outwardly from the first arm of the clip, wherein the second pair of top and bottom wings extends outwardly from the second arm of the clip that is opposite the first arm.

4. The clip of claim 3, wherein the clip includes a mounting aperture extending through the first and second arms of the clip, wherein the mounting aperture is configured to enable objects to be mounted to the clip.

5. A hollow member for attaching objects comprising:
a slot, wherein the slot has first and second longitudinal ends, wherein the slot includes first notches extending along a length of the first longitudinal end, wherein the slot includes second notches extending along the length of the second longitudinal end, wherein the first and second notches are located opposite each other, wherein the slot is configured to receive a clip, wherein the clip includes first and second sides located opposite each other, wherein the clip includes a first detent located on the first side of the clip and a second detent located on the second side of the clip, wherein the slot is configured to receive the clip such that the first detent engages one of the first notches and the second detent engages one of the second notches opposite the first notch engaged by the first detent, wherein the hollow member is configured to enable the first and second detents to disengage from their respective first and second notches to enable the clip to be moved along a length of the slot to a position where the first detent can engage another one of the first notches and the second detent can engage another one of the second notches.

6. The hollow member of claim 5, wherein the slot includes an access portion at an inner axial end of the slot that is of larger width than the remaining portion of the slot, wherein the access portion is sized to enable the clip to be inserted into the slot.

7. An apparatus for attaching objects comprising:
a hollow member, wherein the hollow member includes a first slot, wherein the first slot has first and second longitudinal ends, wherein the first slot includes first notches extending along a length of the first longitudinal end, wherein the first slot includes second notches extending along the length of the second longitudinal end, wherein the first and second notches are located opposite each other; and
a first clip, wherein the first clip includes first and second sides located opposite each other, wherein the first clip includes a first detent located on the first side of the first clip and a second detent located on the second side of the first clip, wherein the first clip is configured to be inserted into the first slot such that the first detent engages one of the first notches and the second detent engages one of the second notches opposite the first notch engaged by the first detent to attach the first clip to the hollow member, wherein the first clip is configured to enable the first and second detents to disengage from their respective first and second notches to enable the first clip to be moved along a length of the first slot to a position where the first detent can engage another one of the first notches and the second detent can engage another one of the second notches.

8. The apparatus of claim 7, wherein the first clip includes a first pair of top and bottom wings, wherein the first pair of top and bottom wings extends outwardly from the first side of the first clip, wherein the first clip includes a second pair of top and bottom wings, wherein the second pair of top and bottom wings extends outwardly from the second side of the first clip that is opposite the first side, wherein each of the first and second pairs of the top and bottom wings is configured to sandwich a wall of the hollow member when the first clip is inserted into the first slot to hold the first clip to the hollow member.

9. The apparatus of claim 7, wherein the first clip comprises a first arm located on the first side of the first clip and a second arm located on a second side of the first clip, wherein the first and second arms extend upwardly and outwardly away from each other together forming a V-shape configuration, wherein the first arm incudes a first projection that defines the first detent, wherein the second arm includes a second projection that defines the second detent.

10. The apparatus of claim 9, wherein the first clip includes a first pair of top and bottom wings, wherein the first pair of top and bottom wings extends outwardly from the first arm of the first clip, wherein the first clip includes a second pair of top and bottom wings, wherein the second pair of top and bottom wings extends outwardly from the second arm of the first clip that is opposite the first arm, wherein each of the first and second pairs of the top and bottom wings is configured to sandwich a wall of the hollow member when the first clip is inserted into the first slot to hold the first clip to the hollow member.

11. The apparatus of claim 7, wherein the first clip includes a mounting aperture extending through the first and second side of the first clip, wherein the mounting aperture is configured to enable objects to be mounted to the first clip.

12. The apparatus of claim 7, wherein the first clip is inserted into the first slot such that the first detent engages one of the first notches and the second detent engages one of the second notches opposite the first notch engaged by the first detent to attach the first clip to the hollow member, wherein the first and second detents may be disengaged from their respective first and second notches to enable the first clip to be moved along a length of the first slot to another position where the first detent can engage another one of the first notches and the second detent can engage another one of the second notches.

13. The apparatus of claim 12, further comprises:
a second slot, wherein the second slot is spaced longitudinally from the first slot, wherein the second slot has third and fourth longitudinal ends, wherein the second slot includes third notches extending along a length of the third longitudinal end, wherein the second slot includes fourth notches extending along the length of the fourth longitudinal end, wherein the third and fourth notches are located opposite each other; and
a second clip, wherein the second clip includes third and fourth sides located opposite each other, wherein the clip includes a third detent located on the third side of the second clip and a fourth detent located on the fourth side of the second clip, wherein the second clip is inserted into the second slot such that the third detent engages one of the third notches and the fourth detent engages one of the fourth notches opposite the third notch engaged by the third detent to attach the second clip to the hollow member, wherein the third and fourth detents may be disengaged from their respective third and fourth notches to enable the second clip to be moved along a length of the second slot to a position where the third detent can engage another one of the third notches and the fourth detent can engage another one of the fourth notches.

14. The apparatus of claim 13, wherein the first clip includes a first pair of top and bottom wings, wherein the first pair of top and bottom wings extends outwardly from the first side of the first clip, wherein the first clip includes a second pair of top and bottom wings, wherein the second pair of top and bottom wings extends outwardly from the second side of the first clip that is opposite the first side, wherein each of the first and second pairs of the top and bottom wings sandwiches a wall of the hollow member to hold the first clip to the hollow member, wherein the second clip includes a third pair of top and bottom wings, wherein the third pair of top and bottom wings extends outwardly from the third side of the second clip, wherein the second clip includes a fourth pair of top and bottom wings, wherein the fourth pair of top and bottom wings extends outwardly from the fourth side of the second clip that is opposite the third side, wherein each of the third and fourth pairs of the top and bottom wings sandwiches the wall of the hollow member to hold the first clip to the hollow member.

15. The apparatus of claim 13, wherein the first clip comprises a first arm located on the first side of the first clip and a second arm located on a second side of the first clip, wherein the first and second arms extend upwardly and outwardly away from each other together forming a V-shape configuration, wherein the first arm includes a first projection that defines the first detent, wherein the second arm includes a second projection that defines the second detent, wherein the second clip comprises a third arm located on the third side of the second clip and a fourth arm located on a fourth side of the second clip, wherein the third and fourth arms extend upwardly and outwardly away from each other together forming a V-shape configuration, wherein the third arm includes a third projection that defines the third detent, wherein the fourth arm includes a fourth projection that defines the fourth detent.

16. The apparatus of claim 15, wherein the first clip includes a first pair of top and bottom wings, wherein the first pair of top and bottom wings extends outwardly from the first arm of the first clip, wherein the first clip includes a second pair of top and bottom wings, wherein the second pair of top and bottom wings extends outwardly from the second arm of the first clip that is opposite the first arm, wherein each of the first and second pairs of the top and bottom wings sandwiches a wall of the hollow member when the first clip is inserted into the first slot to hold the first clip to the hollow member, wherein the second clip includes a third pair of top and bottom wings, wherein the third pair of top and bottom wings extends outwardly from the third arm of the second clip, wherein the second clip includes a fourth pair of top and bottom wings, wherein the fourth pair of top and bottom wings extends outwardly from the fourth arm of the second clip that is opposite the third arm, wherein each of the third and fourth pairs of the top and bottom wings sandwiches the wall of the hollow member to hold the first clip to the hollow member.

17. The apparatus of claim 16, wherein the second clip includes a mounting aperture extending through the first and second side of the first clip, wherein the mounting aperture is configured to enable objects to be mounted to the first clip.

18. The apparatus of claim 13, wherein the first clip is configured to enable the first and second sides to be squeezed toward each other to enable the first and second detents to disengage from their respective first and second notches to enable the first clip to be moved along the length of the first slot to the position where the first detent can engage the another one of the first notches and the second detent can engage the another one of the second notches upon removing the squeezing force, wherein the second clip is configured to enable the third and fourth sides to be squeezed toward each other to enable the third and fourth detents to disengage from their respective third and fourth notches to enable the second clip to be moved along the length of the second slot to a position where the third detent can engage the another one of the third notches and the fourth detent can engage the another one of the fourth notches upon removing the squeezing force.

19. The apparatus of claim 7, wherein the first clip is configured to enable the first and second sides to be squeezed toward each other to enable the first and second detents to disengage from their respective first and second notches to enable the first clip to be moved along the length of the first slot to the position where the first detent can engage the another one of the first notches and the second detent can engage the another one of the second notches upon removing the squeezing force.

20. The apparatus of claim 7, wherein the slot includes an access portion at an inner axial end of the slot that is of larger width than the remaining portion of the slot, wherein the access portion is sized to enable the clip to be inserted into the slot.
